(19) United States
(12) Patent Application Publication
(10) Pub. No.: US 2022/0081781 A1
(43) Pub. Date: Mar. 17, 2022

(54) SYSTEM AND METHOD FOR TRANSPORTING HYDROGEN PRODUCED FROM SEAWATER BASED ON EXISTING OFFSHORE WIND POWER PLANT

(71) Applicant: ZHEJIANG UNIVERSITY, ZHEJIANG (CN)

(72) Inventors: Ronghua ZHU, Zhejiang (CN); Hengfeng WANG, Zhejiang (CN); Zhisheng TU, Zhejiang (CN); Hanqiu LIU, Zhejiang (CN); Xiang SUN, Zhejiang (CN); Qingfu XU, Zhejiang (CN); Peiling CHEN, Zhejiang (CN)

(73) Assignee: ZHEJIANG UNIVERSITY, ZHEJIANG (CN)

(21) Appl. No.: 17/243,572

(22) Filed: Apr. 29, 2021

(30) Foreign Application Priority Data
Sep. 14, 2020 (CN) 202010959819.6

(51) Int. Cl. C25B 1/04; F03D 9/25; C25B 1/50; C25B 15/08; C25B 9/65; F17C 9/00

(52) U.S. Cl. CPC C25B 1/04; F03D 9/25; C25B 1/50; C25B 15/08; C25B 9/65; H02G 9/00; F05B 2220/61; F05B 2220/705; F05B 2220/706; F17C 2221/012; F17C 2270/0105; F17C 9/00

(57) ABSTRACT

The present invention belongs to the field of offshore wind power and, in particular, relates to system for transporting hydrogen produced from seawater and method based on an existing offshore wind power plant. The system comprises a wind generator, a seawater electrolytic cell device and a hydrogen transporting unit, wherein the wind generator is configured for converting wind energy into electric energy, the seawater electrolytic cell device is configured for electrolyzing seawater by making using of electric energy supplied by the wind generator and the hydrogen transporting unit is configured for transporting hydrogen produced by the seawater electrolytic cell device to a land. According to the present invention, by combining offshore wind power with seawater hydrogen production, resource advantages of the offshore wind power plant is utilized fully, so that the seawater hydrogen production cost is lowered.

### CROSS-REFERENCE TO RELATED APPLICATION

This application claims the priority benefit of China application serial no. 202010959819.6, filed on Sep. 14, 2020. The entirety of the above-mentioned patent application is hereby incorporated by reference herein and made a part of this specification.

### BACKGROUND

### Technical Field

The invention belongs to the field of offshore wind power and in particular relates to a system and method for transporting hydrogen produced from seawater based on an existing offshore wind power plant.

As a renewable energy source, offshore wind power has been developed very rapidly in recent years. The offshore distance of the offshore wind plant is usually larger than 10 km, and in the offshore wind plant, there is rich wind resources and abundant seawater resources to be developed and utilized by human.

According to the time-honored water-electrolytic hydrogen production technology, water is electrolyzed to generate hydrogen and oxygen. Hydrogen is the substance with the highest energy density known in the world. Hydrogen is combusted without carbon dioxide, so that global warming problem can be alleviated, and therefore the water-electrolytic hydrogen production technology is one of solutions for clean energy sources in the future. Existing water-electrolytic technologies are substantially based on pure water and are accomplished on land while little attention has been paid to over 95% ground water sources: seawater. On the other hand, the water-electrolytic hydrogen production technology needs continuous electric energy supply. If water-electrolytic hydrogen production is carried out offshore, a power supply will be a major problem.

Based on the problems, the disclosure provides a system and method for transporting hydrogen produced from seawater based on an existing offshore wind power plant. Water-electrolytic hydrogen production can be conducted by using the abundant seawater resources and the problem of power supply in the electrolytic process can be further solved.

### SUMMARY

In order to overcome defects in the prior art, the present invention provides a technical scheme of a system and method for transporting hydrogen produced from seawater based on an existing offshore wind power plant.

A system for transporting hydrogen produced from seawater based on an existing offshore wind power plant includes:

a wind generator configured for converting wind energy into electric energy;

a seawater electrolytic cell device configured for electrolyzing seawater by making use of electric energy supplied by the wind generator; and

a hydrogen transporting unit configured for transporting hydrogen produced by the seawater electrolytic cell device to a land.

The system for transporting hydrogen produced from seawater based on the existing offshore wind power plant, characterized in that the hydrogen transporting unit includes a large hydrogen storage tank and a transport ship, the large hydrogen storage tank being used for storing hydrogen and the transport ship being used for extracting hydrogen in the large hydrogen storage tank periodically and transporting the hydrogen to the land.

The system for transporting hydrogen produced from seawater based on the existing offshore wind power plant, characterized in that the hydrogen transporting unit includes an offshore booster station, a transmission line and a hydrogen transporting pipeline, the offshore booster station being used for boosting a current transmitted by the wind generator, the transmission line being used for transporting electric energy generated by the wind generator and the hydrogen transporting pipeline being used for transporting hydrogen, and the hydrogen transporting pipeline and the transmission line being in fit connection and paved jointly.

The system for transporting hydrogen produced from seawater based on the existing offshore wind power plant, characterized in that the transmission line is a submarine cable.

The system for transporting hydrogen produced from seawater based on the existing offshore wind power plant, characterized in that the hydrogen transporting unit includes a plurality of small hydrogen storage tanks and a transport ship, the small hydrogen storage tanks being used for storing hydrogen and the transport ship being used for transporting the small hydrogen storage tanks to the land.

A method for transporting hydrogen produced from seawater based on an existing offshore wind power plant, the method including:

S1: converting wind energy into electric energy by a wind generator;

S2: electrolyzing seawater by a seawater electrolytic cell device to produce hydrogen, wherein electric energy needed by the seawater electrolytic cell device (2) is supplied by the wind generator; and

S3: transporting the produced hydrogen to a land.

The method for transporting hydrogen produced from seawater based on the existing offshore wind power plant, characterized in that the step S3 specifically includes the steps of: storing hydrogen produced by the seawater electrolytic cell device in a large hydrogen storage tank first and then extracting hydrogen in the large hydrogen storage tank periodically and transporting the hydrogen to the land by a transport ship.

The method for transporting hydrogen produced from seawater based on the existing offshore wind power plant, characterized in that the step S3 specifically includes the steps of: transporting electric energy generated by the wind generator to the land through a transmission line and boosting a current through an offshore booster station on the one hand, and transporting the hydrogen to the land by the hydrogen transporting pipeline which is paved jointly with and in fit connection with the transmission line on the other hand.

The method for transporting hydrogen produced from seawater based on the existing offshore wind power plant, characterized in that the transmission line is a submarine cable.

The method for transporting hydrogen produced from seawater based on the existing offshore wind power plant, characterized in that the step S3 specifically includes the steps of: storing the hydrogen produced by the seawater electrolytic cell device in a small hydrogen storage tank first and then transporting the small hydrogen storage tank to the land by the transport ship.

The present invention has the beneficial effects that by combining offshore wind power with seawater hydrogen production, resource superiority of the offshore wind power plant is utilized fully, so that the seawater hydrogen production cost is lowered, and finally, harmonious development of offshore environment-friendly wind energy and seawater hydrogen production is achieved.

### BRIEF DESCRIPTION OF THE DRAWINGS

FIG. 1 is a structural schematic diagram of the system for transporting hydrogen produced from seawater of the embodiment 1.

FIG. 2 is a structural schematic diagram of the system for transporting hydrogen produced from seawater of the embodiment 2.

FIG. 3 is a structural schematic diagram of the system for transporting hydrogen produced from seawater of the embodiment 3.

### DESCRIPTION OF THE EMBODIMENTS

The present invention will be further elaborated hereafter in connection with the drawings.

### Embodiment 1

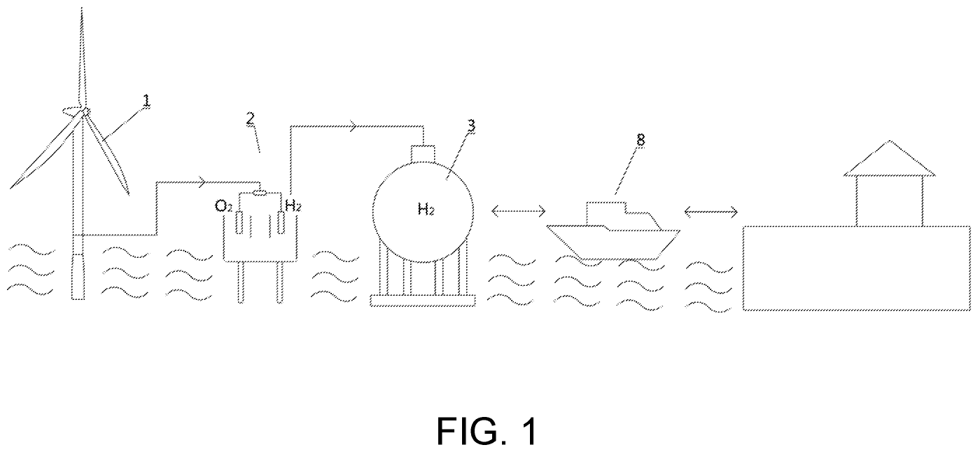

As shown in the FIG. 1, a system for transporting hydrogen produced from seawater includes a wind generator 1, a seawater electrolytic cell device 2 and a hydrogen transporting unit. The wind generator 1 is used for converting wind energy into electric energy, the seawater electrolytic cell device 2 is used for electrolyzing seawater by means of electric energy supplied by the wind generator 1 and the hydrogen transporting unit is used for transporting hydrogen manufactured by the seawater electrolytic cell device 2 to a land. In particular, the hydrogen transporting unit includes a large hydrogen storage tank 3 and a transport ship 8, the large hydrogen storage tank 3 being used for storing hydrogen and the transport ship 8 being used for extracting hydrogen in the large hydrogen storage tank 3 periodically and transporting the hydrogen to the land. The bottom of the large hydrogen storage tank 3 is erected on a seabed through a pile foundation and the transport ship 8 is provided with a tank for storing hydrogen.

A produced hydrogen transporting system of the system for transporting hydrogen produced from seawater includes:

S1: converting wind energy into electric energy by the wind generator 1;

S2: electrolyzing seawater by means of the seawater electrolytic cell device 2 to manufacture hydrogen, wherein electric energy needed by the seawater electrolytic cell device 2 is supplied by the wind generator 1; and

S3: conveying the manufactured hydrogen to the land.

Further description on step S1: converting, by the wind generator 1, wind energy into electric energy, conveying most electric energy to a power grid on the land and in addition, supplying a small part of electric energy to the seawater electrolytic cell device 2 to use electricity;

Further description on step S2: mounting the seawater electrolytic cell device 2 in a proper position of the wind power plant, extracting, by the seawater electrolytic cell device 2, seawater from a peripheral sea area to be stored in an electrolytic cell, and electrolyzing, by the seawater electrolytic cell device 2, the seawater stored therein into hydrogen and oxygen, wherein hydrogen can be conveyed to the land to be used as a fuel and the like by human.

Specific operation of step S3 includes: compressing and storing hydrogen manufactured by the seawater electrolytic cell device 2 in the large hydrogen storage tank 3 first and then extracting hydrogen in the large hydrogen storage tank 3 periodically and conveying the hydrogen to the land by the transport ship 8.

Compared with a conventional electrolytic hydrogen production method, the embodiment has the advantages and innovation points below:

1. The seawater electrolytic cell device 2 is mounted offshore for electrolytic hydrogen production, which can solve the problem of shortage of fresh water for electrolytic hydrogen in the land and make full use of abundant water sources in sea.

2. The seawater is electrolyzed by means of electric energy generated by the wind generator 1, which can solve the problem of energy supply in hydrogen production by offshore electrolysis of seawater.

3. Hydrogen is pre-stored in the large hydrogen storage tank 3 and is then conveyed to the land by means of the transport ship 8, which is high in operability and convenient to store hydrogen.

4. An offshore wind power technology and a seawater hydrogen production technology are combined, which promotes environment-friendly energy development greatly, thereby making a contribution to energy conservation and emission reduction.

5. A wind power system and a seawater hydrogen production system are maintained simultaneously in later operation and maintenance, which improves the operation and maintenance efficiency and saves the operation and maintenance cost.

### Embodiment 2

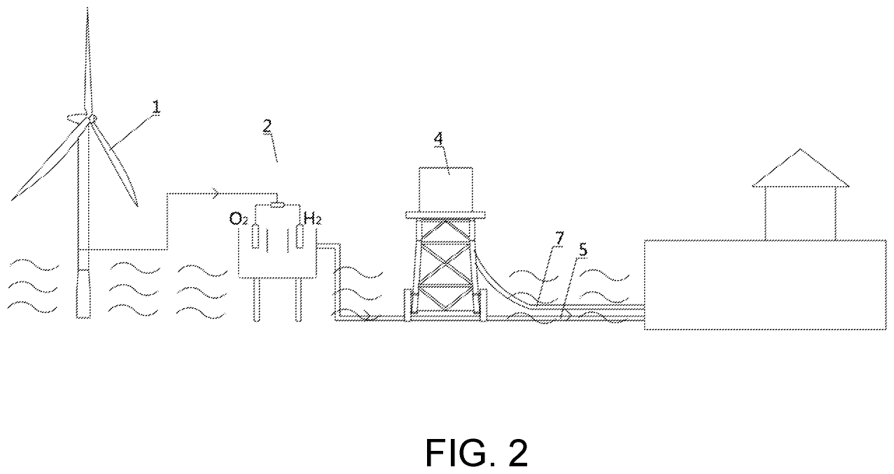

As shown in the FIG. 2, a system for transporting hydrogen produced from seawater includes a wind generator 1, a seawater electrolytic cell device 2 and a hydrogen transporting unit. The wind generator 1 is used for converting wind energy into electric energy, the seawater electrolytic cell device 2 is used for electrolyzing seawater by means of electric energy supplied by the wind generator 1 and the hydrogen transporting unit is used for transporting hydrogen produced by the seawater electrolytic cell device 2 to a land. In particular, the hydrogen transporting unit includes an offshore booster station 4, a transmission line 7 and a hydrogen transporting pipeline 5, the offshore booster station 4 being used for boosting a current transmitted by the wind generator 1, the transmission line 7 being used for conveying electric energy generated by the wind generator 1 and the hydrogen transporting pipeline 5 being used for transporting hydrogen, and the hydrogen transporting pipeline 5 and the transmission line 7 being in fit connection and being paved jointly. The transmission line 7 is a submarine cable.

A produced hydrogen transporting system of the system for transporting hydrogen produced from seawater includes:

S1: converting wind energy into electric energy by the wind generator 1;

S2: electrolyzing seawater by means of the seawater electrolytic cell device 2 to manufacture hydrogen, wherein electric energy needed by the seawater electrolytic cell device 2 is supplied by the wind generator 1; and

S3: conveying the manufactured hydrogen to the land.

Further description on step S1: converting, by the wind generator 1, wind energy into electric energy, conveying most electric energy to a power grid on the land and in addition, supplying a small part of electric energy to the seawater electrolytic cell device 2 to use electricity;

Further description on step S2: mounting the seawater electrolytic cell device 2 in a proper position of the wind power plant, extracting, by the seawater electrolytic cell device 2, seawater from a peripheral sea area to be stored in an electrolytic cell, and electrolyzing, by the seawater electrolytic cell device 2, the seawater stored therein into hydrogen and oxygen, wherein hydrogen can be conveyed to the land to be used as a fuel and the like by human.

Specific operation of step S3 includes: conveying electric energy generated by the wind generator 1 to the land through the transmission line 7 and boosting the current of the offshore booster station 4 on the one hand and conveying hydrogen to the land by means of the hydrogen transporting pipeline 5 which is paved jointly along with the transmission line 7 and is in fit connection to the hydrogen transporting pipeline 5 on the other hand. The transmission line 7 is a submarine cable which is bundled to the hydrogen transporting pipeline 5.

Further description on step S3: the hydrogen transporting pipeline 5 adopts the original transmission line 7 of the wind power plant, which can save the long-distance transportation cost of hydrogen. Submarine cable engineering is regarded as complex and difficult large engineering by various countries in the world. Complex technologies are applied to environmental detection, oceanophysical investigation and design, manufacturing and mounting of cables. In an earlier stage of construction, it is needed to carry out marine geographic survey to plan a proper submarine cable paving line in advance to avoid a frequent ship operation area and prevent the submarine cable from being damaged when an anchor is dropped as well as to avoid an area with complex submarine topography to reduce the construction difficulty. In the final stage of construction, deep bury protection is mainly carried out on the submarine cable so as to reduce influence of complex marine environment to the submarine cable, so that the operation safety is guaranteed. In sand and sludge areas, a groove which is about 2 m is generated by high pressure flushing, the cable is buried into the groove, and the cable is covered by lateral sand; in coral reef and clay areas, a 0.6-1.2 m deep groove is cut by using a cutter, the cable is buried into the groove, and natural backfilling is performed to form protection; In hard rock areas, it is needed to cover the cable with hard objects such as a cement cover plate to implement protection, construction operations such as route investigation, surveying, paving, maintenance, removal and the like of the submarine cable and the pipeline must not impair offshore normal order, a special paving ship is needed for paving the submarine cable, the paving cost is high, and the cost of the 35 KV submarine cable per km is about 300-350 thousand. Compared with the submarine cable, the submarine hydrogen pipeline is larger in diameter and harder to construct. If the submarine hydrogen pipeline is paved independently, the cost is far higher than that of the submarine cable. In the embodiment, the hydrogen transporting pipeline 5 and the original submarine cable of the wind power plant are paved together by sharing one paving ship, so that the early stage investigation cost of the hydrogen pipeline is saved. The hydrogen transporting pipeline 5 and the submarine cable are deeply buried and protected in the later construction period, thereby, saving the paving cost of the hydrogen transporting pipeline greatly.

Compared with a conventional electrolytic hydrogen production method, the embodiment has the advantages and innovation points below:

1. The seawater electrolytic cell device 2 is mounted offshore for electrolytic hydrogen production, which can solve the problem of shortage of fresh water for electrolytic hydrogen in the land and make full use of abundant water sources in sea.

2. The seawater is electrolyzed by means of electric energy generated by the wind generator 1, which can solve the problem of energy supply in hydrogen production by offshore electrolysis of seawater.

3. Hydrogen is transported by means of a pipeline of the existing offshore booster station 4, so that the long-distance transportation cost of hydrogen can be saved, and a technical support is provided to seawater hydrogen production by means of an existing resource of the offshore wind plant.

4. An offshore wind power technology and a seawater hydrogen production technology are combined, which promotes environment-friendly energy development greatly, thereby making a contribution to energy conservation and emission reduction.

5. A wind power system and a seawater hydrogen production system are maintained simultaneously in later operation and maintenance, which improves the operation and maintenance efficiency and saves the operation and maintenance cost.

### Embodiment 3

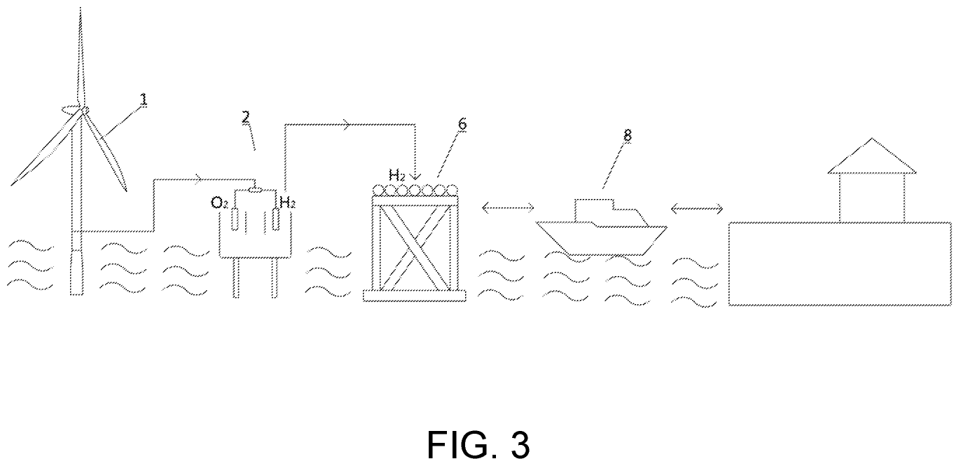

As shown in the FIG. 3, a system for transporting hydrogen produced from seawater includes a wind generator 1, a seawater electrolytic cell device 2 and a hydrogen transporting unit. The wind generator 1 is used for converting wind energy into electric energy, the seawater electrolytic cell device 2 is used for electrolyzing seawater by means of electric energy supplied by the wind generator 1 and the hydrogen transporting unit is used for transporting hydrogen produced by the seawater electrolytic cell device 2 to a land. In particular, the hydrogen transporting unit includes a plurality of small hydrogen storage tanks 6 and a transport ship 8, the small hydrogen storage tanks 6 being used for storing hydrogen and the transport ship 8 being used for conveying the small hydrogen storage tanks 6 to the land. The small hydrogen storage tanks 6 are placed on an offshore platform and the transport ship 8 is provided with a tank for storing hydrogen.

A produced hydrogen transporting system of the system for transporting hydrogen produced from seawater includes:

S1: converting wind energy into electric energy by the wind generator 1;

S2: electrolyzing seawater by means of the seawater electrolytic cell device 2 to manufacture hydrogen, wherein electric energy needed by the seawater electrolytic cell device 2 is supplied by the wind generator 1; and

S3: conveying the manufactured hydrogen to the land.

Further description on step S1: converting, by the wind generator 1, wind energy into electric energy, conveying most electric energy to a power grid on the land and in addition, supplying a small part of electric energy to the seawater electrolytic cell device 2 to use electricity;

Further description on step S2: mounting the seawater electrolytic cell device 2 in a proper position of the wind power plant, extracting, by the seawater electrolytic cell device 2, seawater from a peripheral sea area to be stored in an electrolytic cell, and electrolyzing, by the seawater electrolytic cell device 2, the seawater stored therein into hydrogen and oxygen, wherein hydrogen can be conveyed to the land to be used as a fuel and the like by human.

Specific operation of step S3 includes: placing many small hydrogen storage tanks 6 on the offshore platform, storing hydrogen manufactured by the seawater electrolytic cell device 2 in the small hydrogen storage tanks 6 first, and then conveying the small hydrogen storage tanks 6 to the land by the transport ship 8 after most small hydrogen storage tanks 6 store hydrogen fully. Compared with the embodiment 1, the embodiment 3 can omit the step of extracting hydrogen by the transport ship 8, so that the transportation efficiency is improved.

Compared with a conventional electrolytic hydrogen production method, the embodiment has the advantages and innovation points below:

1. The seawater electrolytic cell device 2 is mounted offshore for electrolytic hydrogen production, which can solve the problem of shortage of fresh water for electrolytic hydrogen in the land and make full use of abundant water sources in sea.

2. The seawater is electrolyzed by means of electric energy generated by the wind generator 1, which can solve the problem of energy supply in hydrogen production by offshore electrolysis of seawater.

3. Hydrogen is stored by the small hoyden storage tanks 6 and then the small hoyden storage tanks 6 are conveyed to the land by the transport ship 8, which omits the step of extracting hydrogen by the transport ship 8, thereby improving the transportation efficiency.

4. An offshore wind power technology and a seawater hydrogen production technology are combined, which promotes environment-friendly energy development greatly, thereby making a contribution to energy conservation and emission reduction.

5. A wind power system and a seawater hydrogen production system are maintained simultaneously in later operation and maintenance, which improves the operation and maintenance efficiency and saves the operation and maintenance cost.

At last, it should be stated that the above various embodiments are only used to illustrate the technical solutions of the present invention without limitation; and despite reference to the aforementioned embodiments to make a detailed description of the present invention, those of ordinary skilled in the art should understand: the described technical solutions in above various embodiments may be modified or the part of or all technical features may be equivalently substituted; while these modifications or substitutions do not make the essence of their corresponding technical solutions deviate from the scope of the technical solutions of the embodiments of the present invention.

What is claimed is:

1. A system for transporting hydrogen produced from seawater based on an existing offshore wind power plant, the system comprising:
a wind generator (1) configured for converting wind energy into electric energy;
a seawater electrolytic cell device (2) configured for electrolyzing seawater by making use of electric energy supplied by the wind generator (1); and
a hydrogen transporting unit configured for transporting hydrogen produced by the seawater electrolytic cell device (2) to a land.

2. The system for transporting hydrogen produced from seawater based on the existing offshore wind power plant according to claim 1, wherein the hydrogen transporting unit comprises a large hydrogen storage tank (3) and a transport ship (8), the large hydrogen storage tank (3) being used for storing hydrogen and the transport ship (8) being used for extracting hydrogen in the large hydrogen storage tank (3) periodically and transporting the hydrogen to the land.

3. The system for transporting hydrogen produced from seawater based on the existing offshore wind power plant according to claim 1, wherein the hydrogen transporting unit comprises an offshore booster station (4), a transmission line (7) and a hydrogen transporting pipeline (5), the offshore booster station (4) being used for boosting a current transmitted by the wind generator (1), the transmission line (7) being used for transporting electric energy generated by the wind generator (1) and the hydrogen transporting pipeline (5) being used for transporting hydrogen, and the hydrogen transporting pipeline (5) and the transmission line (7) being in fit connection and paved jointly.

4. The system for transporting hydrogen produced from seawater based on the existing offshore wind power plant according to claim 3, wherein the transmission line (7) is a submarine cable.

5. The system for transporting hydrogen produced from seawater based on the existing offshore wind power plant according to claim 1, wherein the hydrogen transporting unit comprises a plurality of small hydrogen storage tanks (6) and a transport ship (8), the small hydrogen storage tanks (6) being used for storing hydrogen and the transport ship (8) being used for transporting the small hydrogen storage tanks (6) to the land.

6. A method for transporting hydrogen produced from seawater based on an existing offshore wind power plant, the method comprising:
S1: converting wind energy into electric energy by a wind generator (1);
S2: electrolyzing seawater by a seawater electrolytic cell device (2) to produce hydrogen, wherein electric energy needed by the seawater electrolytic cell device (2) is supplied by the wind generator (1); and
S3: transporting the produced hydrogen to a land.

7. The method for transporting hydrogen produced from seawater based on the existing offshore wind power plant according to claim 6, wherein the step S3 specifically comprises the steps of: storing hydrogen produced by the seawater electrolytic cell device (2) in a large hydrogen storage tank (3) first and then extracting hydrogen in the large hydrogen storage tank (3) periodically and transporting the hydrogen to the land by a transport ship (8).

8. The method for transporting hydrogen produced from seawater based on the existing offshore wind power plant according to claim 6, wherein the step S3 specifically comprises the steps of: transporting electric energy generated by the wind generator (1) to the land through a transmission line (7) and boosting a current through an offshore booster station on the one hand, and transporting the hydrogen to the land by the hydrogen transporting pipeline (5) which is paved jointly with and in fit connection with the transmission line (7) on the other hand.

9. The method for transporting hydrogen produced from seawater based on the existing offshore wind power plant according to claim 8, wherein the transmission line (7) is a submarine cable.

10. The method for transporting hydrogen produced from seawater based on the existing offshore wind power plant according to claim 6, wherein the step S3 specifically comprises the steps of: storing the hydrogen produced by the seawater electrolytic cell device (2) in a small hydrogen storage tank (6) first and then transporting the small hydrogen storage tank (6) to the land by the transport ship (8).
